(19) United States
(12) Patent Application Publication
(10) Pub. No.: US 2008/0144450 A1
(43) Pub. Date: Jun. 19, 2008

(54) METHOD FOR DATA PRESERVATION

(75) Inventor: Yi-Chang Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/675,093

(22) Filed: Feb. 15, 2007

(30) Foreign Application Priority Data
Dec. 13, 2006 (TW) 95146577

(51) Int. Cl. G11B 21/08

(52) U.S. Cl. 369/30.01

(57) ABSTRACT

A method for data preservation is disclosed. In the method, the number of times the processor accesses a sector of a storage device is counted, which is used to determine the damage level of the sector. The data stored in the sector is moved and stored to a normal sector when the number of accessing times exceeds a certain number. Moreover, the user will be prompted with a message to execute disk defragment when the number of damaged sectors is over a predetermined value. Therefore, the purpose of ensuring the security and the integrity of the data stored in the sector can be achieved.

### CROSS-REFERENCE TO RELATED APPLICATION

This application claims the priority benefit of Taiwan application serial no. 95146577, filed Dec. 13, 2006. All disclosure of the Taiwan application is incorporated herein by reference.

### BACKGROUND OF THE INVENTION

1. Field of the Invention

The present invention relates to a method for data preservation, more data.

2. Description of Related Art

As the electronic technology continues to develop and improve, the manufacturing costs for computer continue to decrease. As a result, the popularity of computers rises year by year. Consequently, computer users become more and more accustomed to using hard drive of the computer, which is considered the most commonly used storage device, to store data. Although hard drives encompass advantages such as large capacity, low manufacturing costs and the ability to reread and rewrite, the sectors of hard drives are prone to damages due to long-term use, computer virus attack, and frequent access to computer network such as peer to peer (P2P). Frequent reading and writing of the hard drive will result in accessing errors when retrieving the data stored in the hard drive.

When faced with this kind of problem, the earlier version of MS-DOS system usually displays a dialog box showing accessing error to notify the user that an error has occurred when accessing the hard drive and ask the user whether to perform another data access. Under the circumstance when too many sectors of the hard drive are damaged and once an accessing error has occurred, the step of asking the user whether to perform another data access will cause too much inconvenience. Moreover, MS-DOS system does not keep any record of the damage level of the hard drive. Therefore, the user may not be aware of the damage level of the hard drive because the user is still able to repeatedly retrieve the data stored in the hard drive. When the data can no longer be retrieved from the erroneous sector during data access, recovering the data stored in the hard drive will be a laborious and time-consuming process and part of the data might have been lost.

Microsoft Windows operating system usually skips the step of asking the user for confirmation when accessing a damaged sector of the hard drive and directly tries to retrieve the data stored in the sector of the hard drive. As a result, the pop-up of too many dialog boxes can be avoided. Unfortunately, Microsoft Windows operating system also does not, however, keep any record of the erroneous sector or the damage level of the hard drive. Oftentimes, the user cannot predetermine which sector might be damaged to the point that none of the data can be retrieved and backup the stored data in advance to prevent such irreversible losses.

### SUMMARY OF THE INVENTION

The present invention is directed to a method for data preservation. The method counts the number of retry times for accessing the sector of the storage device when an error occurs. An attention sector data table is constructed based on the aforementioned number to determine the damage level of the sector. Further, the data in the sector is automatically moved and stored before the sector is damaged to the extent that the data can no longer be accessed and before complete destruction of the sector, acting as a precaution that prevents the stored data from losing due to the damage of the hard drive.

Accordingly, the present invention provides a method for data preservation that is used to preserve data stored in the sector of the storage device. This method for data preservation includes the following steps. First, when an accessing error occurs during data access of a sector and another data access is performed, this sector is designated as a first sector and a counter is used to count the number of retry times in the first sector. Then, the number of retry times is determined whether it is greater than a first predetermined value. When the number of retry times is greater than the first predetermined value, the sector address of the first sector is determined whether it is included in an attention sector data table, wherein the attention sector data table is stored in either the storage device or other reliable storage device. If the sector address has already been saved to the attention sector data table, the counter is used to count the number of error times for this particular sector address and the counted value is updated to the attention sector data table. Next, the number of error times is determined whether it is greater than a second predetermined value. When the number of error times is greater than the second predetermined value, the data stored in the first sector is moved and stored to a secure and unused sector, which is designated as the second sector. Then, the first sector is marked as damaged, which will no longer be allocated for use by the operating system.

According to an embodiment of the present invention, the method for data preservation further comprises adding the sector address of a sector that has not been included in the attention sector data table to the attention sector data table and recording the number of error times of the corresponding sector address as 1.

According to an embodiment of the present invention, when the number of error times is smaller than the second predetermined value, the data in this sector is accessed again and the number of retry times is counted once more till the number of error times is greater than a third predetermined value. Then, the data of the first sector is moved and stored to a safe and unused second sector and the first sector is marked as damaged which will no longer be allocated for use by the operating system.

According to an embodiment of the present invention, it further comprises adding up all the numbers included in the attention sector data table to determine whether the total value is greater than a fourth predetermined value. If the total value is greater than the fourth predetermined value, the storage device will be prompted for defragment.

According to an embodiment of the present invention, ways of prompting the defragment of the storage device include prompting an alert dialog box.

According to an embodiment of the present invention, when accessing data from each sector, it is determined whether an abnormal signal has been received. When an abnormal signal is received, the data stored in this sector is accessed again.

According to an embodiment of the present invention, ways of moving the data stored in the sector address include moving or copying the data of the sector address to other undamaged sector.

According to an embodiment of the present invention, the storage device includes a hard drive or other memory storage device.

The present invention counts the number of times that the sector is accessed to determine the damage level of the sector. When the number of accessing the attention sector reaches a certain predetermined value, the data stored in the sector is automatically moved and stored to another sector. The readability and integrity of the stored data is backed up and preserved before the complete destruction of the sector.

In order to make the aforementioned and other objects, features and advantages of the present invention more comprehensible, some embodiments accompanied with figures are described in detail below.

### BRIEF DESCRIPTION OF THE DRAWINGS

FIG. 1 is a schematic view illustrating the steps of preserving data according to an embodiment of the present invention.

FIG. 2 is a schematic view illustrating the attention sector data table according to an embodiment of the present invention.

FIG. 3 is a schematic view illustrating the attention sector data table according to another embodiment of the present invention.

FIG. 4 is a schematic view illustrating the steps of preserving data according to another embodiment of the present invention.

FIG. 5 is a schematic view illustrating the steps of preserving data according to yet another embodiment of the present invention.

### DESCRIPTION OF EMBODIMENTS

In order to make the present invention more comprehensible, embodiments are described below as examples to prove that the invention can actually be realized.

Generally, the time required for accessing a damaged sector of a storage device is much longer than that for accessing a normal sector of the same storage device. This is because it takes repeated accessing to obtain the data stored in the damaged sector of the storage device. Therefore, the number of error times for assessing the sector of the storage device reflects the damage level of the sector. The present invention is a method for preserving data developed based on the aforementioned principle.

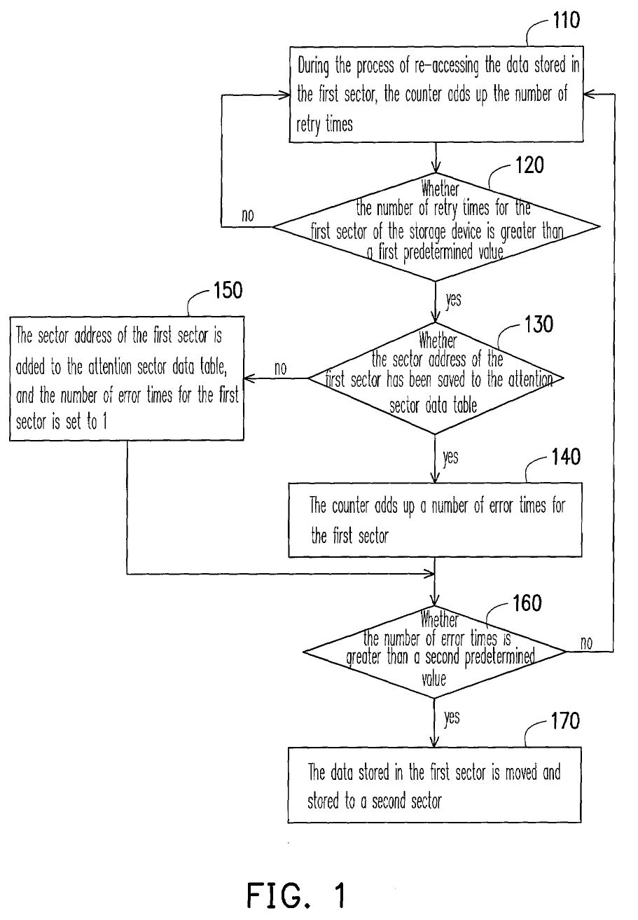

FIG. 1 is a schematic view illustrating the steps of preserving data. In FIG. 1, the present embodiment is used in preserving the data stored in a first sector of a storage device, wherein the storage device can be, but not limited to, a hard drive or a memory structure having a device that allows data to be written, stored and read. Details are illustrated below.

If the processor receives an abnormal signal when accessing the data stored in the first sector, it is likely that the storage device contains a damaged sector. Meanwhile, the processor will repeatedly access the data stored in the first sector till the data is read as, illustrated by step 110. During the process of re-accessing the data stored in the first sector, the counter adds up the number of retry times.

Next, in step 120, it is determined whether the number of retry times for the first sector of the storage device is greater than a first predetermined value. If the number of retry times is smaller than or equal to the first predetermined value, then the method goes back to step 110 to wait till the next cycle of accessing the data stored in the first sector and restart counting the number of accessing times. However, if the number of re-accessing times is greater than the first predetermined value, the method proceeds to step 130 to determine whether the sector address of the first sector has been saved to the attention sector data table. The attention sector data table keeps a record of the sector addresses of the erroneous sectors and the corresponding number of retry times for each sector. In the present embodiment, the attention sector data table can be stored in, but not limited to, a second sector of the storage device, a memory structure or other different storage device.

If the sector address of the first sector has already been saved to the list of the known erroneous sector data, the counter adds up a number of error times for the first sector (step 140). Alternatively, if the sector address of the first sector has not been saved to the attention sector data table, a new field corresponding to the first sector is added to the attention sector data table for recording the sector address of the first sector, and the number of error times for the first sector is set to 1 (step 150). The number of error times keeps a record of the number of errors made by each sector during data access and is used to reflect a particular sector that is showing instability during data access.

Nonetheless, one unstable data access of a sector does not mean that sector is damaged but it might be due to an external factor such as overheating or tilting of the hard drive. However, if such circumstances occur repeatedly, it is likely that the sector is erroneous and should be directed to subsequent preservation steps. Hence, after adding up the number of error times for the first sector, the method proceeds to determine whether the calculated value is greater than a second predetermined value (step 160). If the number of error times for the first sector is smaller than or equal to the second predetermined value, then the method goes back to step 110 to wait till the next cycle of accessing the data stored in the first sector and repeats step 120 through step 160 till the number of error times is greater than the second predetermined value. If the number of error times for the first sector is greater than the second predetermined value, as illustrated by step 170, the data stored in the first sector is moved and stored to, for instance, a secure and unused second sector of the storage device. Moreover, the first sector is marked as damaged and will no longer be allocated for use by the operating system. In the present embodiment, ways of moving or storing data include, for instance, moving or copying the data stored in the sector address of the first sector to other undamaged sector.

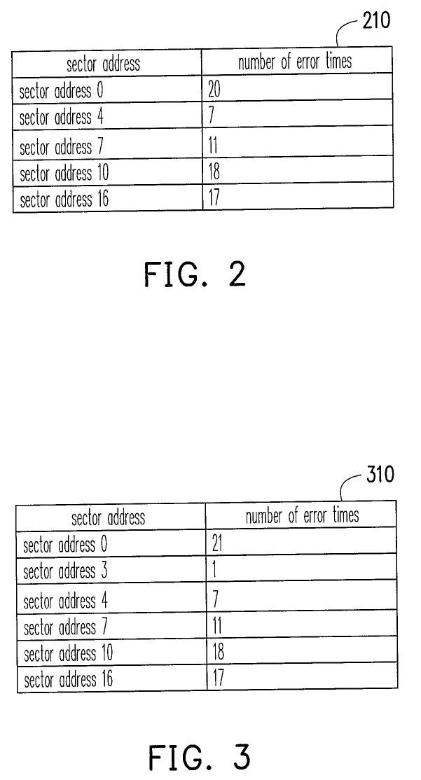

In one embodiment of the present invention, to facilitate illustration, the first predetermined value is assumed to be 100 and the second predetermined value is assumed to be 20. When the processor performs the 121^{st} time of re-accessing for the sector 0 of the storage device (the number of retry time for the sector 0 is 121), such as the hard drive, it should be noted that the number of retry time is greater than the assumed first predetermined value. As illustrated by FIG.2, the sector address 0 of the sector 0 has been previously saved to the attention sector data table 210. Further, the number of error times for the sector 0 increases from 20 to 21 as illustrated by the second row of the attention sector data table 310 in FIG. 3. After the number of error times for the sector 0 is determined to be 21, which is greater than the assumed second predetermined value of 20, the processor will instruct the data stored in the sector 0 to be moved or stored to the other undamaged sector of the hard drive.

In the previous embodiment, besides moving or storing the data to the undamaged sector of the original storage device, the same data can be backed up to, but not limited to, other storage device such as an external hard drive.

In another embodiment, when the processor is re-accessing the data stored in the third sector for the 101^{st} time, the number 101 of retry times for the third sector is greater than the assumed first predetermined value (i.e. 100). In FIG. 2, since the sector address of the third sector has not been saved to the attention sector data table 210, the attention sector data table 210 will add a new row for recording the sector address 3 of the third sector, and the number of error times is set to 1. The updated result is illustrated by the third row of the attention sector data table 310 in FIG. 3.

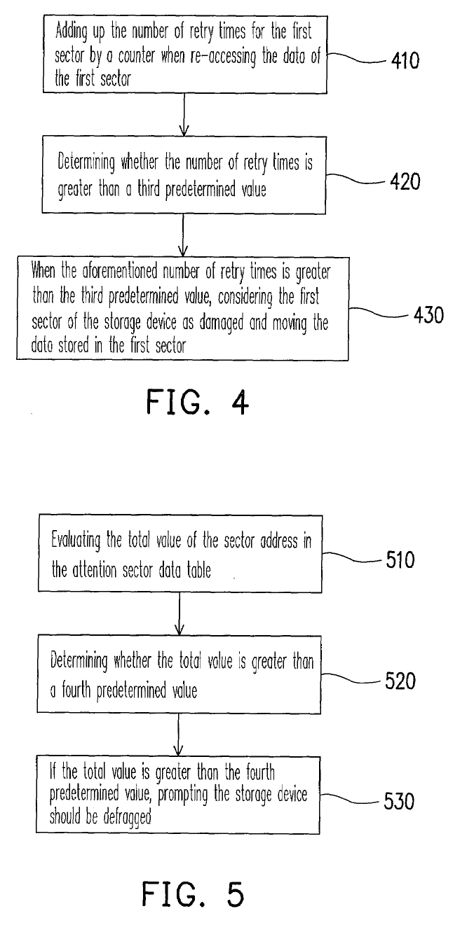

FIG. 4 is a schematic view illustrating the steps of preserving data according to another embodiment of the present invention. Please refer to FIG. 4. In the present embodiment, if the processor receives an abnormal signal when accessing the data stored in the first sector of the storage device, it is likely that the first sector is damaged. When the processor re-accesses the first sector, as illustrated by step 410, a counter adds up the number of retry times for the first sector. Next, in step 420, it is determined whether the number of retry times is greater than a third predetermined value, wherein the third predetermined value is greater than the first predetermined value. The third predetermined value is used to determine whether a particular sector is erroneous and whether subsequent preservation steps should be instructed when the sector is severely damaged and the number of retry times has reached hundreds or thousands, causing a considerable burden to the system and drastically affecting the efficiency of the system.

Therefore, in step 430, when the aforementioned number of retry times is greater than the third predetermined value, the first sector of the storage device will be considered as damaged and the data stored in the first sector will be moved and stored to, for instance, other undamaged sector of the storage device.

Assume the third predetermined value is 1000. When the processor is re-accessing the first sector of the storage device for the 1001^{st} time, the number of retry times is 1001, which is greater than the assumed third predetermined value of 1000. Further, the processor will automatically consider the first sector as damaged and backup the data stored in the first sector. In the present embodiment, the storage device can be, but not limited to, a hard drive or a memory structure having a device that performs data access. Moreover, the data can be backed up to, for instance, other undamaged sector of the storage device or a different storage device such as an external hard drive.

FIG. 5 is a schematic view illustrating the steps of preserving data according to yet another embodiment of the present invention. When too many sectors of the storage device are damaged, the system will repeatedly fail to access the data, which results in severe conditions such as crashing of the system. Therefore, the present embodiment includes steps succeeding step 150 in FIG.1. When adding a new sector address to the attention sector data table, the total value of the sector address in the attention sector data table is added up (step 510). In the attention sector data table, each recorded sector address corresponds to the occurrence of error for the sector. Next, in step 520, the total value is determined whether it is greater than a fourth predetermined value. If the total value is greater than the fourth predetermined value, it can be determined that the storage device contains too many erroneous sectors and the system is tending to be unstable. Therefore, the user will be prompted to defrag the storage device (step 530). Herein, ways of prompting the defragment of the storage device include, for instance, prompting a dialog box to notify the user that the number of damaged sectors in the storage device has reached a certain extent and there is a need to defrag the storage device in order to maintain the security of the stored data.

In one embodiment, assume the fourth predetermined value is 4. As illustrated by FIG. 2, the total value of adding up all the sector addresses of the corresponding re-accessed sectors in the attention sector data table is 5, which is greater than the assumed fourth predetermined value of 4. Meanwhile, the processor will prompt a dialog box to notify the user that too many sectors of the storage device are damaged and request the user to defrag the storage device.

Accordingly, the data preservation method of the present invention determines the damage level of a sector based on the number of re-accessing times for the sector of the storage device. When the number of re-accessing times for the sector exceeds a predetermined value, the data stored in the sector will be automatically moved or stored to other undamaged sector address. Simultaneously, when too many sectors are damaged, the user will be prompted to defrag the storage device. As a result, the integrity and security of the data is preserved through backing up the data without interfering the user's operation of the system.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method for preserving data that is used for preserving the data stored in a first sector of a storage device and the method for preserving data comprising the following steps:
(a) when re-accessing the data stored in the first sector, a counter is used to count a number of retry times for re-accessing the first sector;
(b) determining whether the number of retry times is greater than a first predetermined value;
(c) when the number of retry times is greater than the first predetermined value, determining whether a sector address of the first sector has been saved to an attention sector data table and the attention sector data table is saved in a second sector;
(d) if the sector address has already been saved to the attention sector data table, the counter is used to count a number of error times for this particular sector address and the counted value is updated to the attention sector data table;
(e) determining whether the number of error times is greater than a second predetermined value; and
(f) when the number of error time is greater than the second predetermined value, moving and storing the data of the sector address to a third sector.

2. The method of claim 1, wherein the step (d) further comprises:
if the sector address has not been saved to the attention sector data table, the sector address of the first sector will be added to the attention sector data table and the corresponding number of error times for the sector address is recorded as 1.

3. The method of claim 1, after the step (e), further comprising:
(g) when the number of error times is smaller than or equal to the second predetermined value, repeat step (a) through step (d) till the number of error times is greater than a third predetermined value before proceeding to step (f).

4. The method of claim 1, after the step (a), further comprising:
determining whether the number of retry times is greater than a third predetermined value, wherein the third predetermined value is greater than the first predetermined value; and
when the number of retry times is greater than the third predetermined value, considering the sector as damaged and moving the data stored in the sector address.

5. The method of claim 1, further comprising:
adding up all the sector addresses in the attention sector data table to obtain a total value;
determining if the total value is greater than a fourth predetermined value; and
if the total value is greater than the fourth predetermined value, prompting the storage device should be defragged.

6. The method of claim 5, wherein ways of prompting the storage device should be defragged comprise prompting an alert dialog box.

7. The method of claim 1, prior to the step (a), further comprising:
determining if an abnormal signal is received when accessing data of each sector; and
when an abnormal signal is received, accessing the data stored in the first sector again.

8. The method of claim 1, wherein ways of moving the data stored in the sector address comprise:
moving or copying the data of the sector address to other undamaged sector.

9. The method of claim 1, wherein the storage device comprises a hard drive or a memory structure.
